(19) United States
(12) Patent Application Publication
(10) Pub. No.: US 2019/0116247 A1
(43) Pub. Date: Apr. 18, 2019

(54) Retractable Stylus Retainer For Use With a Mobile Device

(71) Applicant: Corles Andre GILES, Tomball, TX (US)

(72) Inventor: Corles Andre GILES, Tomball, TX (US)

(21) Appl. No.: 16/086,483

(22) PCT Filed: Oct. 15, 2015
(86) PCT No.: PCT/US2015/055787

§ 371 Date: Sep. 19, 2018

(51) Int. Cl. H04M 1/02; G06F 3/0354; G06F 3/039; B65H 75/44; B66D 1/60

(52) U.S. Cl. CPC H04M 1/026; G06F 3/03545; G06F 3/039; A45F 5/021; B65H 75/4421; B66D 1/60; B65H 75/4471

(57) ABSTRACT

An accessory to a mobile device which secures a stylus to the device or device case such that the stylus is extractable for use, and retractable for storage. They stylus being attached to the accessory by a retractable cord so that it may not be separated from the device or misplaced. The accessory further includes a stand to support the mobile device at a convenient angle to allow use with the stylus.

### BACKGROUND OF THE INVENTION

This invention relates to a retractable stylus retainer for mobile electronics.

Mobile phones and other handheld electronic devices have historically used a stylus for performing detailed tasks on a touch screen. This allows the user finer control when selecting small areas of the screen, prevents the device from accumulating skin oils or dirt, and is useful in low temperatures when the user is wearing gloves. Typically the stylus is either stored separately from the device, or stored within the device by some mechanism which retains the stylus.

However, as device sizes grew smaller, many electronics which may utilize stylus no longer have a built in mechanism for retaining the stylus. In these devices, the stylus is easily misplaced or forgotten, or the user may have difficulty locating the stylus in cluttered storage locations such as a pocket or purse. In addition, many phones and other mobile devices with a built in stylus are designed in such a way that placing the phone in a protective case to prevent breakage would prevent access to the stylus.

When using a phone to type, the user often is forced to hunch over the phone in an uncomfortable position or work in insufficient lighting because the phone is flat on the table. The phone may be used in an angled or upright position by employing a phone stand. However, stands for a phone may interfere with use of a stylus due to occupying the space in which a stylus would be stored. This problem is compounded if the user of the phone employs a case to protect or decorate their phone, as the stylus and stand may be obstructed by use of the case, and the stand may not engage adequately with the phone with a case present.

### SUMMARY OF THE INVENTION

Described herein is a retractable stylus retainer for use with a mobile device. The retainer may be affixed to electronic devices such as, but not limited to, IPads, digital assistants, phones, and music playing devices. The retainer comprises a clip, receptacle, or opening for securing a stylus when not in use, a stylus attachment point is detachably connected to one end of an optionally included stylus, a flexible member extending from the stylus attachment point to the body of the retainer. The flexible member being coilable around a spool which is biased by a spring to retract the flexible member onto the spool.

The stylus attachment point allows a specialized stylus unique to the user's device to be employed. The stylus may be retractable, or folding to form a more compact configuration when stored. The stylus attachment point may include a plug to connect the cords to the stylus for active components such as optical readers, lights, or scanners.

In one embodiment, the flexible member is a cord, string, or ribbon which connects to a passive stylus. In another embodiment, the flexible member is one or more wires, or conductors providing data and/or power connection to an active stylus. In one embodiment the spool further comprises a clutch mechanism which locks it in one of a plurality of positions as the cord is extracted or retracted.

In another embodiment the flexible member passes through an opening in the retainer housing. The opening is sufficiently large enough to allow the flexible member to pass uninhibited on one side, and tapers toward another side to allow the flexible member to be wedged into the taper such that it is restrained from passing in either direction until removed from the tapered side. In another embodiment the retainer housing has a rigid projection extending from the body at an angle to the body such that a taper is formed near the rigid projection's point of connection to the retainer housing. The flexible member being wedgeable into the taper to secure the flexible member at a given point along its length.

The retainer may be attached to an existing mobile device housing, or a case. In one embodiment the retainer may be secured to the device housing or case by screws. In another embodiment the retainer may be molded into the materials of the case or housing. In another embodiment a latching mechanism removably connects the retainer. In another embodiment the retainer may be semi-permanently secured by glue or adhesive.

The retainer may further comprise a retractable prop or stand which elevates at least one side of the mobile device from the surface of the table so that it is placed in an upright or angled position. This allows the user to view the screen and/or type more comfortably and effectively. In one embodiment the stand may be pivotable. In another embodiment the stand may be recessed into one side of the retainer.

In one embodiment, the stand may be removable or replaceable. In another embodiment the stand may also comprise a clip for securing the device to a belt, clothing, or other semi flat material. In one embodiment, the opening in the housing for the cord to pass to the spool is located such that retracting the cord pulls the stylus into its storage position on the retainer housing.

In the preferred embodiment, a stylus retainer has a housing with a void into which a retractable stylus is securely but removably inserted. The retainer includes a telescoping stylus which is removably attached to a stylus attachment point on one end of a flexible cord. The cord passes through an opening in the retainer housing which allows free passage of the cord.

The end distal to the stylus coils around a spool with a clutch mechanism. The retainer is secured to the device or case with double sided adhesive tape. The side opposite the device comprises a stand which is hinged on one end and in the stored position folds into a recess on the side of the retainer. The stand, in the extended position, holds the device in a position angled against the supporting surface. For the sake of clarity, the remainder of the discussion will be limited to the preferred embodiment described above. One skilled in the art would appreciate the broader applicability of the concepts discussed herein.

### BRIEF DESCRIPTION OF THE DRAWINGS

FIG. 1 shows a mobile device or a device case with a retractable stylus retainer mounted thereto in accordance with an exemplary embodiment of the invention.

FIG. 2 shows a cut-away view of a retractable spool in a stylus retainer in accordance with an exemplary embodiment of the invention.

FIG. 3 shows a retracting mechanism for the stylus in isolation in accordance with an exemplary embodiment of the invention.

FIG. 4 shows a retention slot through which the stylus cord passes in accordance with an exemplary embodiment of the invention.

FIG. 5 shows an alternate mechanism for retaining the stylus cord at a desired length in accordance with an exemplary embodiment of the invention.

FIG. 6 shows an extendable stylus which may be compactly stored within the phone case in accordance with an exemplary embodiment of the invention.

FIG. 7 shows a phone case with a retractable stylus retainer incorporating a folding stand into the retracting mechanism in accordance with an exemplary embodiment of the invention.

FIG. 8 shows the mechanism of FIG. 7 with the support in the deployed position.

### DETAILED DESCRIPTION OF THE PREFERRED EMBODIMENTS

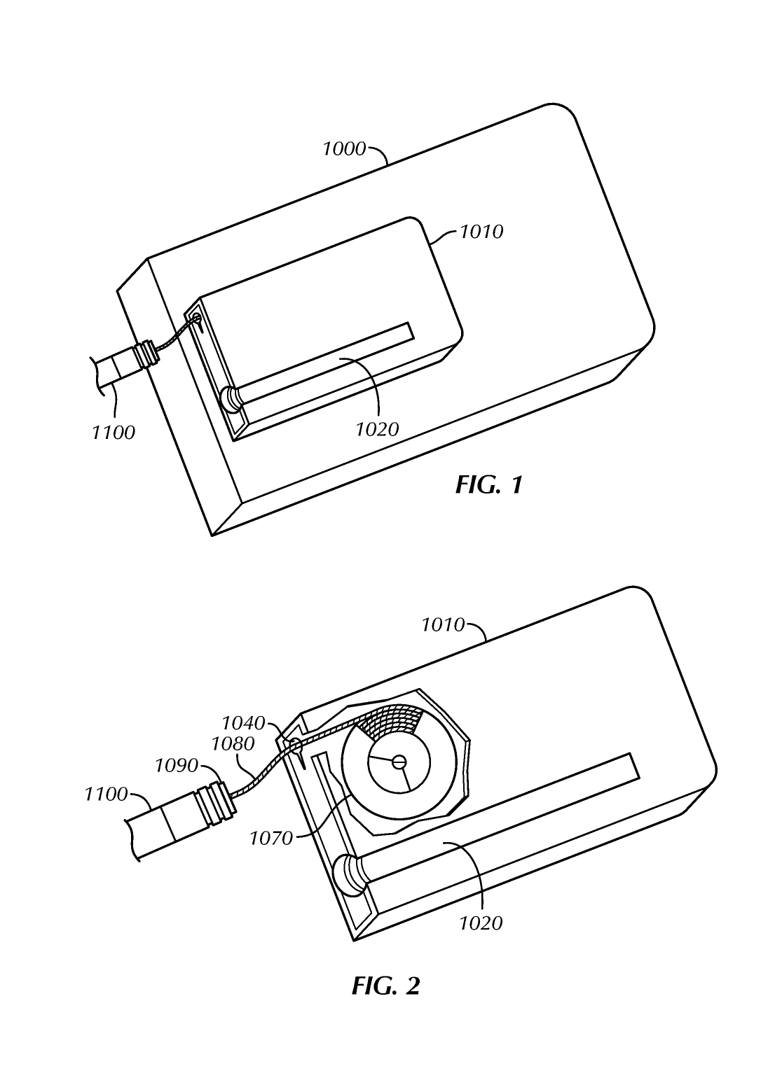

FIG. 1 shows a mobile device or a device case with a retractable stylus retainer mounted thereto in accordance with an exemplary embodiment of the invention. The mobile device or device case (1000), shown from the back has attached thereto the retractable stylus retainer (1010). The stylus retainer has a stylus storage slot (1020) for securing the stylus (1100) when not in use.

FIG. 2 shows a cut-away view of a retractable spool in a stylus retainer in accordance with an exemplary embodiment of the invention. The cut-away of the retractable stylus retainer (1010) shows the spool (1070) with the cord (1080) wound around, and extending out of the cord opening (1040) to connect to the stylus attachment point (1090) on top of the stylus (1100). The stylus (1100) can be secured in the stylus storage slot (1020) when not in use.

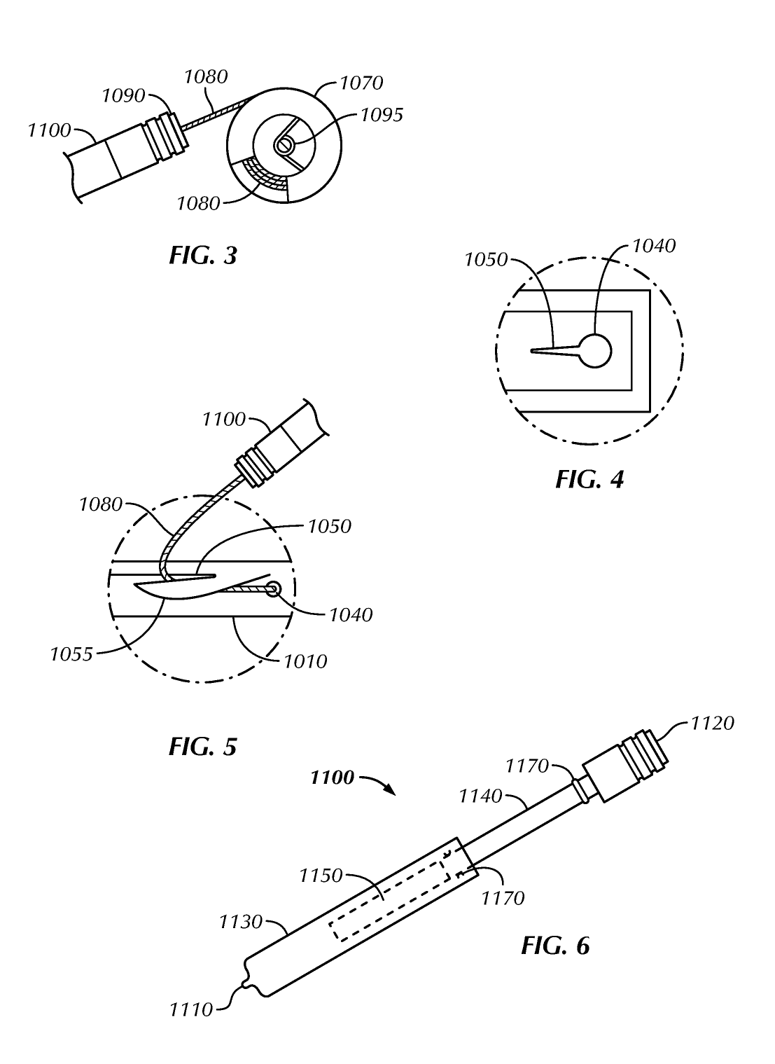

FIG. 3 shows a retracting mechanism for the stylus in isolation in accordance with an exemplary embodiment of the invention. The stylus (1100) is pulled via the stylus attachment point (1090) by the cord (1080) which is wound around the spool (1070) which is biased to retract by the spring mechanism (1095).

FIG. 4 shows a retention slot through which the stylus cord passes in accordance with an exemplary embodiment of the invention. The cord opening (1040), previously illustrated in FIG. 2, is tapered to one side forming a retention slot (1050) into which the cord can be wedged to secure it against the biasing spring to a specific length.

FIG. 5 shows an alternate mechanism for retaining the stylus cord at a desired length in accordance with an exemplary embodiment of the invention. In this embodiment, the stylus's (1100) cord (1080) passes through the cord opening (1040), and is secured in a taper (1050) formed by a case extension (1055) which angles away from the body of the case (1010).

FIG. 6 shows an extendable stylus which may be compactly stored within the phone case in accordance with an exemplary embodiment of the invention. The stylus (1100) has a working end (1110) and a distal attachment end (1120). The body (1130) telescopes an extension (1140) into a cavity (1050) when not in use to reduce overall length. The body (1130) and extension (1140) have a plurality of intersection points (1170) which secure the stylus (1100) in either the extended configuration for use, or the compacted configuration for storage.

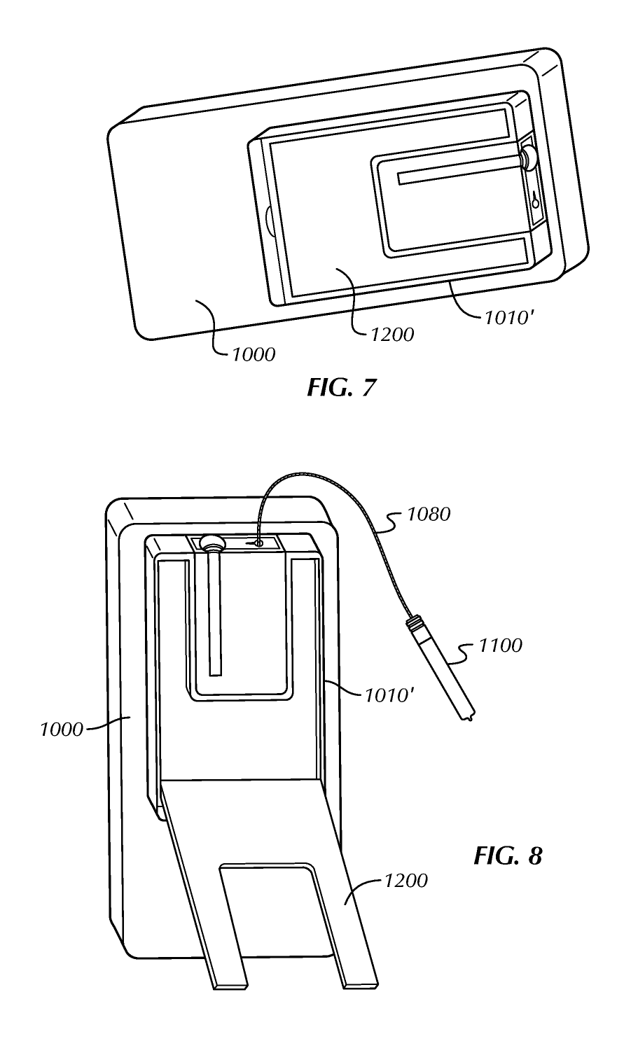

FIG. 7 shows a mobile device or phone case with a retractable stylus retainer incorporating a folding stand into the retracting mechanism in accordance with an exemplary embodiment of the invention. The mobile device or device case (1000), shown from the back, has attached thereto the retractable stylus retainer (1010′) which includes a stand (1200) which is illustrated in the stored position.

FIG. 8 shows the mechanism of FIG. 7 with the support in the deployed position. The mobile device or device case (1000) is shown with the stand (1200) in an extended position as being folded down from the retractable stylus retainer (1010′) to support the device (1000) at an angle so the stylus (1100) attached to the retention cord (1080) is available for use.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A retractable stylus retainer comprising;
a housing, and
a stylus attachment point,
wherein the stylus attachment point is coupled to the housing by a flexible cord.

2. The retractable stylus retainer described in claim 1 further comprising;
a stylus removably attached to the stylus attachment point.

3. The retractable stylus retainer described in claim 1 further comprising;
a cord retracting mechanism comprising a reel and a biasing mechanism biased to create a retracting force on the cord.

4. The retractable stylus retainer described in claim 3;
where the cord retracting mechanism is located internally within the housing.

5. The retractable stylus retainer described in claim 3, further comprising a tapered slot in the housing configured to retain the cord against the bias retracting force to maintain the cord at a desired length such that the cord is not retracted into the retracting mechanism.

6. The retractable stylus retainer described in claim 3, further comprising a clutch mechanism capable of engaging the spool against the bias retracting force retracting the cord.

7. The retractable stylus retainer described in claim 1;
where the stylus is collapsible for compact storage within the casing.

8. The retractable stylus retainer described in claim 1;
where the housing further comprises a means for attaching a stylus to the housing when not in use.

9. The retractable stylus retainer described in claim 8;
where the means for attaching a stylus is a void into which the stylus can be removably secured.

10. The retractable stylus retainer described in claim 3;
where the cord retracting mechanism is located internally within the covering.

11. The retractable stylus retainer described in claim 1 further comprising:
a foldable stand which support the retainer at an angle to the supporting surface.

12. The retractable stylus retainer described in claim 1 further comprising:
means for securing the retainer to a mobile device's housing or a mobile device's protective case.

13. The retractable stylus retainer described in claim 12 wherein the means for securing the retainer comprises semi-permanent adhesive on one side of the retainer.

14. The retractable stylus retainer described in claim 12 wherein the means for securing the retainer comprises double sided foam tape on one side of the retainer.
